(19) United States
(12) Patent Application Publication
(10) Pub. No.: US 2003/0149224 A1
(43) Pub. Date: Aug. 7, 2003

(54) Thermosetting composition

(76) Inventors: Jacobus A Loontjens, Meerssen (NL); Rudolfus A T M Van Benthem, Limbricht (NL); Bartholomeus J M Plum, Ulestraten (NL); Johan Rietberg, Zwolle (NL)

Correspondence Address: PILLSBURY WINTHROP, LLP, P.O. BOX 10500, MCLEAN, VA, 22102, US

(21) Appl. No.: 10/221,017

(22) PCT Filed: Mar. 9, 2001
(86) PCT No.: PCT/NL01/00201

(30) Foreign Application Priority Data
Mar. 10, 2000 (NL) 1014603
Apr. 28, 2000 (EP) 00201533.7
May 31, 2000 (EP) 00201941.2
Nov. 20, 2000 (EP) 00204099.6

(51) Int. Cl. C08G 2/00; C08G 73/10; C08G 69/08

(52) U.S. Cl. 528/220; 528/310; 528/367

(57) ABSTRACT

The invention is related to a thermosetting composition containing a functional resin with —OH or —NH₂ groups, a functionality of more than 2, and a crosslinking agent, wherein the crosslinking agent is a carbonylbislactamate. The composition preferably contains also an acid or a base as a catalyst. The invention further relates to the use of a carbonylbislactamate for curing of a functional resin with —OH or —NH₂ groups and a functionality of more than 2.

The invention relates to a thermosetting composition containing a functional resin with —OH or —NH₂ groups, with a functionality of more than 2 and a crosslinking agent. More specifically, the invention relates to a single-component (1K) resin, notably a 1K-resin for use in solvent-based coatings and in powder coatings.

Known 1K-resins are systems that are based on a resin and a blocked isocyanate as crosslinking agent. Such systems are disclosed in for example the Review paper by D. A. Wicks et al in Progress in Organic Coatings 36 (1999) 148-172.

The crosslinking temperature varies between 100 and 200° C. depending on the type of isocyanate and the group with which the isocyanate is blocked.

Blocked isocyanates commonly used as crosslinking agent are trimers of caprolactam-blocked hexamethylene diisocyanate (HMDI) or isophorone diisocyanate (IPDI). These compounds have molecular weights of 843 and 1005 g/mol, respectively, and a functionality of 3. The molecular weight-per-functionality of these compounds is 281 and 335, respectively. The molecular weight-per-functionality in these blocked isocyanates is relatively high.

Consequently, the drawback of compositions in which blocked isocyanates are present as a crosslinking agent is that these compositions contain relatively large amounts of crosslinker, which is the expensive part in the composition.

The object of the invention is to provide a composition that does not have this drawback.

This object is achieved by the crosslinking agent being a carbonylbislactamate (CBL) with the general formula:

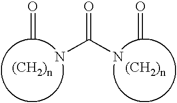

wherein n is an integer from 3 to 15. Preferably the carbonylbislactamate is carbonylbiscaprolactamate (CBC), with n=5.

In CBC, a molecule represented by the following formula,

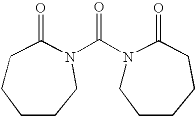

the molecular weight-to-functionality ratio is 126. As a result, compositions with CBC as a crosslinking agent contain relatively few crosslinker. If, for example, a resin contains 60 mmol of —OH groups for each 100 g of resin, 20 g of caprolactam-blocked trimer of IPDI but only 7.5 g of CBC are needed.

Crosslinkers are substantially more costly than resins and therefore heavily affect the cost price of the coating. Thus, an advantage of a coating based on CBL is that such a coating is substantially cheaper than a known coating based on a blocked isocyanate. In contrary to blocked isocyanates is the reaction of the reactive groups in CBL unequal. This offers the possibility to bound the crosslinker to the resin prior to the coating application. The CBL can also be just added to the resin.

The composition of the invention can also contain a catalyst. This ensures that not only amine-terminated resins can be cured but also hydroxy-terminated resins. Catalysts can be acids or bases. The catalyst can be added or bound to the resin.

Acids that are suitable as a catalyst for the crosslinking of resins in the presence of carbonylbislactamate are Sb₂O₃, As₂O₃, dibutyltinlaurate LiX, BX₃, MgX₂, AlX₃, BiX₃, SnX₄, SbX₅, FeX₃, GeX₄, GaX₃, HgX₂, ZnX₂, AlX₃, TiX₄, MnX₂, ZrX₄, R₄NX, R₄PX, or HX where X is H, R, I, Br, Cl, F, acetylacetonate (acac), OR, O(O)CR or combinations of these and R is alkyl or aryl. Brρnstedt acids such as H₂SO₄, HNO₃, HX, H₃PO₄, H₃PO₃, RH₂PO₂, RH₂PO₃, R[(CO)OH]ₙ, where n=1-3, RSO₃H with R is alkyl or aryl, are also suitable.

Bases that are suitable as a catalyst for the crosslinking of resins in the presence of carbonylbislactamate are M(OH)ₙ, (RO)ₙM (M=Alkali or earth alkali), NRₙH₄₋ₙOH (R=alkyl with 1 to 20 carbon atoms or aryl, and n=1-4), tertiary amines including triethylamine, tributylamine, trihexylamine, trioctylamine, guanidine, cyclic amines such as diazobicyclo[2,2,2]octane (DABCO), dimethylaminopyridine (DMAP), and morfoline.

It is preferred for the catalyst to be one of the following compounds:

Ti(OR)₄, Zr(OR)₄, RSO₃H, LiX, LiH, NaH, Li-carboxylate MgX₂, ROM (M is Na, K, Li, Al), Zn(acac)₂, DABCO, DMAP, with R is alkyl with 1 to 20 carbon atoms, or aryl and X is I, Br, Cl or F. This ensures that the time needed for curing is even shorter.

The functional resins may be aminofunctional or hydroxyfunctional polymers. The functionality of the resins is more than 2. Preferably the functionality is more than 2.5. Most preferably the functionality is more than 3.

It is preferred for the resins to be hydroxyfunctional polyethers, hydroxyfunctional polyesters, hydroxyfunctional polyacrylates or hydroxyfunctional polyolefins, or combinations of these.

Thermosetting polyester coatings predominantly contain curable polyester resins which are carboxyl- or hydroxyl-functional to ensure a crosslinking reaction. A wide range of polyesters allows a combination of useful properties such as tunable reactivity, color stability, appearance, corrosion resistance and weathering performance.

A suitable target range for the hydroxyl number of the polyester is between for example 20 and 200 mg KOH/g resin. A more preferable range is between 25 and 100 mg KOH/g resin. The most preferable range is between 30 and 80 mg KOH/g resin. A target range for the acid number may be lower than 25, and the glass transition temperature preferably ranges between 25 and 100 degrees celcius. The molar ratio of the hydroxyl functional groups of the polymer and the lactamate groups of the crosslinker may be between for example 3:1 and 1:3, preferably between 1.5:1 and 1:1.5 and most preferably between 1.2:1 and 1:1.4.

Polyesters are generally based on aliphatic polyalcohols and polycarboxylic acids. The polycarboxylic acids preferably are aromatic carboxylic acids. Aromatic carboxylic acids can be isophtalic acid, terephthalic acid, 2,6-naphthalene dicarboxylic acid, 4,4-oxybisbenzoic acid, or combinations of these.

Other suitable aromatic, cycloaliphatic and/or acyclic polycarboxylic acids useful herein include, for example, 3,6-dichloro phthalic acid, tetrachloro phthalic acid, tetrahydro phthalic acid, hexahydro terephthalic acid, hexachloro endomethylene tetrahydro phthalic acid, phthalic acid, azelaic acid, sebacic acid, decane dicarboxylic acid, adipic acid, succinic acid and maleic acid. These acids may be used as such, or, in so far as available at their anhydrides, acid chlorides or lower alkyl esters. Small amounts of trifunctional acids for example trimelittic acid may be applied to obtain a functionality of more than 2.

Hydroxy carboxylic acids and/or optionally lactones can also be used, such as, for example, 12-hydroxy stearic acid, hydroxy pivalic acid and ε-caprolactone. Monocarboxylic acids, such as, for example, benzoic acid, tert.-butyl benzoic acid, hexahydro benzoic acid and saturated aliphatic monocarboxylic acids, may, if desired, be used in minor amounts.

Useful polyalcohols, in particular diols, reactable with the carboxylic acids to obtain the polyester include aliphatic diols such as, for example, ethylene glycol, propane-1,2-diol, propane-1,3-diol, butane-1,2-diol, butane-1,4-diol, butane-1,3-diol, 2,2-dimethylpropanediol-1,3 (=neopentyl glycol), hexane-2,5-diol, hexane-1,6-diol, 2,2-bis-(4hydroxy-cyclohexyl)-propane (hydrogenated bisphenol-A), 1,4-dimethylolcyclohexane, diethylene glycol, dipropylene glycol, 2,2-bis[4-(2-hydroxy ethoxy)-phenyl] propane, the hydroxy pivalic ester of neopentyl glycol, butyethylpropane diol and ethylmethylpropane diol.

Small amounts, such as less than for example about 20 wt. % and preferably less than 15 wt. %, of trifunctional alcohols may be used in order to obtain a functionality of more than 2. Examples of useful polyols are glycerol, hexanetriol, trimethylol ethane, trimethylol propane and tris-(2-hydroxyethyl)-isocyanurate.

Tetrafunctional monomers generally are not preferred, because these may cause too much branching and gelling, although minute quantities can be used. Examples of useful polyfunctional alcohols and acids are sorbitol, pentaerithritol and pyromellitic acid. However, in order to synthesise branched polyesters, trifunctional monomers are preferred.

The thermosetting coating can be a powder coating. Powder coatings generally comprise a polyester, and a crosslinker, the polyester being based on carboxylic acid and alcohol units, wherein between 10 and 100% of the carboxylic acid units are isophtalic or terephtalic acid units. More preferably between 15 and 100% and most preferably between 75 and 100% of the carboxylic acid units are isophatlic acid units. Between 75 and 100% isophtalic acid units are preferred to improve the outdoor durability of a coating.

Known powder coating compositions for outdoor applications predominantly contain curable polyester resins which are carboxyl- or hydroxyl-functional to ensure a crosslinking reaction. Known curing agents are for example caprolactam blocked isophorone diisocyanate in combination with hydroxyl functional polyesters and triglycidylisocyanurate in combination with carboxyl functional polyesters. A wide range of polyesters allows a combination of useful properties such as tunable reactivity, color stability, appearance, corrosion resistance and weathering performance. The outdoor segment may be subdivided in a durable part being of polyesters comprising about 10-30% isophtalic acid units and 70-90% terephtalic acid units and a superdurable part comprising 100% isophtalic acid units, wherein “durable” must be understood as weather or UV-resistant. An additional advantage of the present invention is that it provides a powder coating composition which has good flow properties and which, after curing, results in a powder coating having an excellent combination of weathering performance, flexibility, and impact resistance.

The powder paint composition according to the invention yields coatings showing good UV-resistance in combination with a good flexibility and good mechanical properties such as for example a good impact resistance. The combination of the superior weathering characteristics and good impact resistance is very surprising.

These characteristics may be achieved after a curing time between for example 1 and 15 minutes at a temperature between for example 135° C. and 250° C.

Preferably the polyester comprises at least 90 mol. % of isophtalic acid units. More preferably the polyester comprises 100 mol. % isopthalic acid units. The preparation of thermosetting powder coatings in general and the chemical reactions for curing powder paints to form cured coatings are described by Misev in Powder Coatings, Chemistry and Technology (1991, John Wiley) on pp. 42-54, p. 148 and pp. 224-226. The usually applied isocyanate/hydroxyl curing reaction is described at pages 56-68. For the crosslinker used in the composition of the invention the curing conditions are basically the same as for powder paint compositions based on blocked isocyanates.

Powder paint compositions according to the present invention can be used on, for example, metal, wooden and plastic substrates. The compositions are also suitable for use in the automotive industry for coating parts and accessories.

The type of non-isophtalic acid units and polyalcohols to be used to prepare the polyester and the curing conditions can be chosen to depend on the desired use.

The compositions according to the invention can be used in pigmented an in unpigmented compositions.

If so desired, the usual additives can be added to the composition according to the invention, such as for example pigments, fillers, dispersing agents, flow-promoting agents degassing agents, and stabilizers. Suitable pigments are for example inorganic pigments, such as for example titanium dioxide, zinc sulphide, iron oxide and chromium oxide, and also organic pigments such as for example azo compounds. Suitable fillers are for example metal oxides, silicates, carbonates and sulphates.

Primary and/or secondary antioxidants, UV stabilizers such as quinones, either or not sterically hindered phenolic compounds, phosphonites, phosphites, thioethers and HALS compounds (hindered amine light stabilizers) can for example be used as stabilizers.

Examples of degassing agents are benzoin and cyclohexane dimethanol bisbenzoate. The flow agents include for example polyalkylacrylates, fluorohydrocarbons and silicone fluids. Other suitable additives are for example additives for improving tribocharging, such as sterically hindered tertiary amines that are described in EP-B-371528.

The thermosetting composition is prepared and cured in a manner known to those skilled in the art for solvent-based coatings and for powder coatings.

Polyesters are prepared according to conventional procedures by esterification or transesterification, optionally in the presence of customary esterification catalysts such as, for instance, dibutyltin oxide or tetrabutyl titanate. Preparation conditions and the COOH/OH ratio can be selected so as to obtain end products that have an acid number and/or a hydroxyl number within the target ranges indicated before.

The invention also relates to a process for the curing of a functional resin with —OH or NH₂ groups and with a functionality of more than 2, in which the resin is cured in the presence of a carbonylbislactamate.

The invention also relates to the use of carbonylbislactamate in the curing of a functional resin with —OH or —NH₂ groups and with a functionality of more than 2.

The invention will be elucidated below on the basis of the following examples.

### EXAMPLE I

A polyester resin comprising 100% isophtalic acid units (Uralac P1580™ of DSM Resins), CBC, flow benzoin were mixed in an extruder at 100° C. The extrudate was cooled, ground and sieved, and the sieve fraction smaller than 90 micrometers was used as powder coating. The powder coating was sprayed electrostatically onto aluminium panels. The panels sprayed with powder coating were cured in a furnace at 200° C. for 30 minutes. The aceton-resistance of this coating turned out to be 30. The mass ratio's of the components are given in table 1.

### EXAMPLE II

Preparation of a Powder Paint Binder Composition and Powder Coating

A polyester resin comprising 100% isophtalic acid units (Uralac P1580™ of DSM Resins), CBC, tetrabutyl titanate, flow benzoin were mixed in an extruder at 100° C. The extrudate was cooled, ground and sieved, and the sieve fraction smaller than 90 micrometers was used as powder coating. The powder coating was sprayed electrostatically onto aluminium panels. The panels sprayed with powder coating were cured in a furnace at 200° C. for 30 minutes. The mass ratio's of the components are given in table 1.

### COMPARATIVE EXAMPLE A

Example 1 was repeated with the exeption that the crosslinker was replaced by Vestagon B1530™ being trimerized isophoron diisocyanate blocked with caprolactam.

TABLE 1

| | I (pph) | II (pph) | A (pph) |
|---|---|---|---|
| Uralac P1580 | 200 | 200 | 200 |
| Vestagon B1530 | | | 50 |
| CBC | 36 | 36 | |
| Kronos 2160 | 100 | 100 | 100 |
| Resiflow PV5 | 3.0 | 3.0 | 3 |
| Benzoin | 0.8 | 0.8 | 1.5 |
| Tetrabutyl titanate | — | 2.0 | |
| Appearance, | Good | Moderate | Moderate |
| 50 μm | | | |
| Acetone-resistance¹⁾ | 30 | >100 | >100 |
| Quv-B²⁾ | 800 | 800 | 800 |
| 50% retention at 60° gloss | | | |
| (hours) | | | |

¹⁾Acetone resistance determined with acetone double rubs test
²⁾Weather resistance test according to ASTM G 53-88.

These experiments show that the composition according to the invention requires less crosslinker agent than the trimerized diisocyanate blocked composition.

### EXAMPLE III

Preparation

Powder coatings are made by mixing the resin of Example 1, CBC, catalyst, pigment and additives in a blender to obtain the premix. The premix is extruded twice at 110° C. at 200 RPM in a Prism 16 mm twin-screw extruder. The extrudate is grinded and milled in a Retsch mill ZM 100 (0.5 mm sieve) and sieved over a 90 μm sieve (Retsch sieving machine AS 200 Digit) to obtain the powder coating.

The coating is sprayed on a aluminium panel (Al-46), and then cured in a Heraeus oven (UT 6120S) for 15 min. at 200° C. A gradient panel (AlMg3) is sprayed with the powder coating and cured between 150° C.-250° C. for 15 min.

Results

Several catalysts have been used in the powder coatings: paratoluene sulphonic acid (PTSA), Fascat 4102 (butyltin-tris-2-ethylhexanoate), TEHT (tetra-2-ethyl-hexyl-titanate), magnesium chloride, TBT (tetrabutyltitanate) and phosphoric acid. All were tested with 1 wt % catalyst, calculated on crosslinker+resin, except TBT that was tested with 0.85 wt %. In addition, the procedure for TBT was different compared to the other catalysts: 10 g TBT was added to 1000 g molten resin Uralac P1580 (to give NLZ-025080-0491). Thus, in this case the catalysts was not added separately to the premix. Reverse impact was measured according to ASTM-2794/69. The results are given in Table 2a and 2b.

### COMPARATIVE EXAMPLE B

Example III was repeated, wherein Uralac P1580 was cured with Crelan LS 2147 (also a 2-functional crosslinker based on a urethdione) and 0.3 wt % Fascat 4102 (as catalysts). The results are given in Table 2b.

TABLE 2a

| | PTSA | | Fascat 4102 | | TEHT | | MgCl2 | |
|---|---|---|---|---|---|---|---|---|
| in grams | | | | | | | | |
| Uralac P 1580 | 253.5 | | 253.5 | | 253.5 | | 253.5 | |
| CBC | 46.5 | | 46.5 | | 46.5 | | 46.5 | |
| Kronos 2160 | 150 | | 150 | | 150 | | 150 | |
| Resiflow PV 5 | 4.5 | | 4.5 | | 4.5 | | 4.5 | |
| Benzoin | 2.25 | | 2.25 | | 2.25 | | 2.25 | |
| PTSA | 3.0 | | | | | | | |
| Fascat 4102 | | | 3.0 | | | | | |
| TEHT | | | | | 3.0 | | | |
| MgCl2 | | | | | | | 3.0 | |
| Conditions | | | | | | | | |
| Extruder type | Prism 16 mm | | Prism 16 mm | | Prism 16mm | | Prism 16 mm | |
| Extruder temp (° C.) | 110° C. | | 110° C. | | 110° C. | | 110° C. | |
| Nr. of extrusions | 2 | | 2 | | 2 | | 2 | |
| R.p.m. | 200 | | 200 | | 200 | | 200 | |
| Cure Time (min.) | 15 | | 15 | | 15 | | 15 | |
| Cure Temp. (° C.) | 200 | 150-250 | 200 | 150-250 | 200 | 150-250 | 200 | 150-250 |
| Substrate | Al-46 | AlMg3 | Al-46 | AlMg3 | Al-46 | AlMg3 | Al-46 | AlMg3 |
| Test results | | | | | | | | |
| Flow (visual) at 50 μm | 8 | | 8 | | 8 | | 8 | |
| Appearance (visual) | little dist. | | reasonable | | ok | | disturb. | |
| Gloss, 20° | 81 | | 86 | | 77 | | 62 | |
| Gloss, 60° | 95 | | 97 | | 91 | | 93 | |
| Gloss, Haze | 88 | | 70 | | 98 | | 352 | |
| Geltime (s) | 254 | | 144 | | 93 | | 106 | |
| Reverse impact, 50 μm, 60 ip, | nok(5) | | nok(4) | | nok(3) | | nok(4) | |
| initial | | | | | | | | |
| Reverse impact, 50 μm, 60 ip, | nok(5) | | nok(4) | | nok(3) | | nok(4) | |
| 1 day | | | | | | | | |
| Rev, imp, | | nok | | nok | | almost at | | |
| gradient, 50 μm, 160 ip, init. | | | | | | >240° C. | | nok |
| Rev, imp, | | nok | | nok | | almost at | | |
| gradient, 50 μm, 160 ip, 1 day | | | | | | >240° C. | | nok |
| Dr. Lange colour, b* | 0.8 | | 0.4 | | 1 | | 2.8 | |
| Acetone double rubs (ADR) | 100(4) | | 100(3) | | 100(3) | | 100(2) | |
| 100 ADR, gradient (° C.) | | >190 | | >170 | | >165 | | >170 |
| Powder Tg (° C.) | 31.05 | | 30.43 | | 28.56 | | 32.85 | |

1 = best
5 = worst

TABLE 2b

| | | | TBT (different | | | | Fascat 4102 + Crelan | |
|---|---|---|---|---|---|---|---|---|
| | TBT | | formulation) | | Phosphoric acid | | LS2147 ref | |
| in grams | | | | | | | | |
| Uralac P 1580 | | | | | 253.5 | | 203.91 | |
| NLZ-025080-0491 | 253.5 | | 202 | | | | | |
| CBC | 46.5 | | 36 | | 46.5 | | | |
| Kronos 2160 | 150 | | 100 | | 150 | | 150 | |
| Resiflow PV5 | 4.5 | | 3 | | 4.5 | | 4.5 | |
| Benzoin | 2.25 | | 0.8 | | 2.25 | | 2.25 | |
| Fascat 4102 | | | | | | | 6.12 | |
| Phosphoric acid (85%) | | | | | 3 | | | |
| Crelan LS2147 | | | | | | | 96.1 | |
| Conditions | | | | | Blank | | | |
| Extruder type | Prism 16 mm | | Prism 16 mm | | Prism 16mm | | Prism 16 mm | |
| Extruder temp (° C.) | 110° C. | | 110° C. | | 110° C. | | 110° C. | |
| Nr. of extrusions | 2 | | 2 | | 2 | | 2 | |
| R.p.m. | 200 | | 200 | | 200 | | 200 | |
| Cure Time (min.) | 15 | | 15 | | 15 | | 15 | |
| Cure Temp. (° C.) | 200 | 150-250 | 200 | 150-250 | 200 | 150-250 | 200 | 150-250 |
| Substrate | Al-46 | AlMg3 | Al-46 | AlMg3 | Al-46 | AlMg3 | Al-46 | AlMg3 |
| Test results | | | | | | | | |
| Flow (visual) at 50 μm | 9 | | 8.5 | | 7 | | 6 | |
| Appearance (visual) | disturb. | | disturb. | | disturb. | | disturb. | |
| Gloss, 20° | 71 | | 74 | | 68 | | 78 | |
| Gloss, 60° | 90 | | 93 | | 91 | | 93 | |
| Gloss, Haze | 186 | | 178 | | 247 | | 104 | |
| Geltime (s) | 120 | | 119 | | 429 | | 40 | |
| Reverse impact, 50 μm, | nok(4) | | nok(4) | | nok(5) | | nok(3) | |
| 60 ip, initial | | | | | | | | |
| Reverse impact, 50 μm, | nok(4) | | nok(4) | | nok(5) | | nok(3) | |
| 60 ip, 1 day | | | | | | | | |
| Rev. imp, | | almost at | | almost at | | nok | | nok |
| gradient, 50 μm, 160 ip, init. | | 230-240° C. | | >225° C. | | | | |
| Rev, imp, | | almost at | | almost at | | nok | | nok |
| gradient, 50 μm, 160 ip, 1 day | | 230-240° C. | | >225° C. | | | | |
| Dr. Lange colour, b* | 1 | | 0.5 | | 0.4 | | 0.7 | |
| Acetone double rubs (ADR) | 100(3) | | 100(3) | | 100(4) | | 100(3) | |
| 100 ADR,gradient (° C.) | | >180 | | >170 | | 180-210 | | >160 |
| Powder Tg (° C.) | 28.95 | | 30.45 | | 32.33 | | 43.77 | |

1 = best
5 = worst

The amount of CBC required to give good coating results is less than half of the amount required to cure a powder coating with the commercial crosslinker based on a urethdion.

Catalysts giving the best results for the CBC powder coating system (like good flow, colour and acetone resistance) are: Fascat 4102, TEHT and TBT. For the TEHT and TBT it is remarkable that almost full impact is obtained at temperatures of at least 240° C. resp. 230° C. (on the gradiënt panel), which is totally not the case for the system without CBC which had no impact resistance at all.

1. Thermosetting composition containing a functional resin with —OH or —NH₂ groups, with a functionality of more than 2, and a crosslinking agent, characterized in that the crosslinking agent is a carbonylbislactamate, with the general formula: 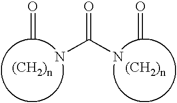
wherein n is an integer from 3 to 15.

2. Thermosetting composition according to claim 1, wherein the composition also contains an acid or a base.

3. Thermosetting composition according to claim 1, or claim 2 in which the crosslinking agent is carbonylbiscaprolactamate.

4. Thermosetting composition according to one of the claims 1-3, wherein the functional resin is a polyester being based on carboxylic acid and polyalcohol units, wherein at least 75 mol % of the carboxylic acid units are isophtalic acid units

5. Thermosetting composition according to claim 4, wherein at least 90 mol % of the carboxylic acid units are isophtalic acid units

6. Thermosetting composition according to claim 5, wherein 100 mol % of the carboxylic acid units are isophtalic acid units

7. Process for the curing of a functional resin with —OH or —NH₂ groups, and with a functionality of more than 2 characterized in that the resin is cured in the presence of a carbonylbislactamate.

8. A coating obtained by curing of a thermosetting composition according to anyone of claims 1-6.
